(19) United States
(12) Patent Application Publication
(10) Pub. No.: US 2013/0038497 A1
(43) Pub. Date: Feb. 14, 2013

(54) ANTENNA AND METHOD FOR MANUFACTURING SAME

(71) Applicants: JungHoon Chae, Suwon (KR); JungMin Kim, Suwon (KR)

(72) Inventors: JungHoon Chae, Suwon (KR); JungMin Kim, Suwon (KR)

(73) Assignees: AAC TECHNOLOGIES HOLDINGS INC., CAYMAN ISLANDS (GB); AAC ACOUSTIC TECHNOLOGIES (SHENZHEN) CO., LTD., Shenzhen (CN)

(21) Appl. No.: 13/548,751

(22) Filed: Jul. 13, 2012

(30) Foreign Application Priority Data
Aug. 11, 2011 (CN) 201110229755.5

(51) Int. Cl. H01Q 1/00; H01P 11/00

(52) U.S. Cl. 343/787; 29/600

(57) ABSTRACT

A method for manufacturing an antenna is disclosed, and the method includes the steps of: providing a wire and a stamping tool, stamping the wire into a flat antenna pattern by the stamping tool, providing a ferrite plate with the antenna pattern attached to the ferrite plate.

### FIELD OF THE INVENTION

The present disclosure relates to radio frequency identification technologies, and more specifically to an antenna and a method for manufacturing the antenna.

### DESCRIPTION OF RELATED ART

With the rapidly development of radio frequency identification technologies, radio frequency identification (RFID) tags are widely used in various fields such as distribution, logistic, material handling industries, and non-contact integrated circuits.

A related radio frequency identification tag includes an antenna and an integrated circuit connected with the antenna for providing object information. And there are various methods provided for manufacturing a radio frequency antenna, such as entwining enameled wires, printing silk screen, or making flexible printed circuit boards (FPCB).

A conventional antenna which is made of FPCB consisting of an insulator layer, a conductive layer having an antenna pattern, and adhesive tapes disposed therebetween. However, the cost for manufacturing such an antenna is increased because the cost of the FPCB unit is high and the FPCB is required for at least two adhesive tapes. Further, it's difficult to make a thin antenna by using FPCB because a typical height of FPCB is at least 0.1 mm and the total thickness of the antenna is accordingly increased. Otherwise, the antenna made of FPCB is easy to be broken because of the poor flexibility of the FPCB.

Therefore, it is desirable to provide a new antenna and a new method which can overcome the above-mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an isometric and exploded view of an antenna in accordance with an exemplary embodiment of the present disclosure;

FIG. 2 is an illustration showing an antenna pattern formed by a stamping tool;

FIG. 3 shows the antenna pattern disposed on an adhesive layer of a ferrite plate in accordance with the exemplary embodiment of the present disclosure.

FIG. 4 shows the antenna pattern attached to an adhesive tape ready to be attached to a ferrite plate in accordance with another embodiment of the present disclosure;

FIG. 5 shows an isometric and exploded view of the antenna in FIG. 4.

### DETAILED DESCRIPTION OF THE EMBODIMENTS

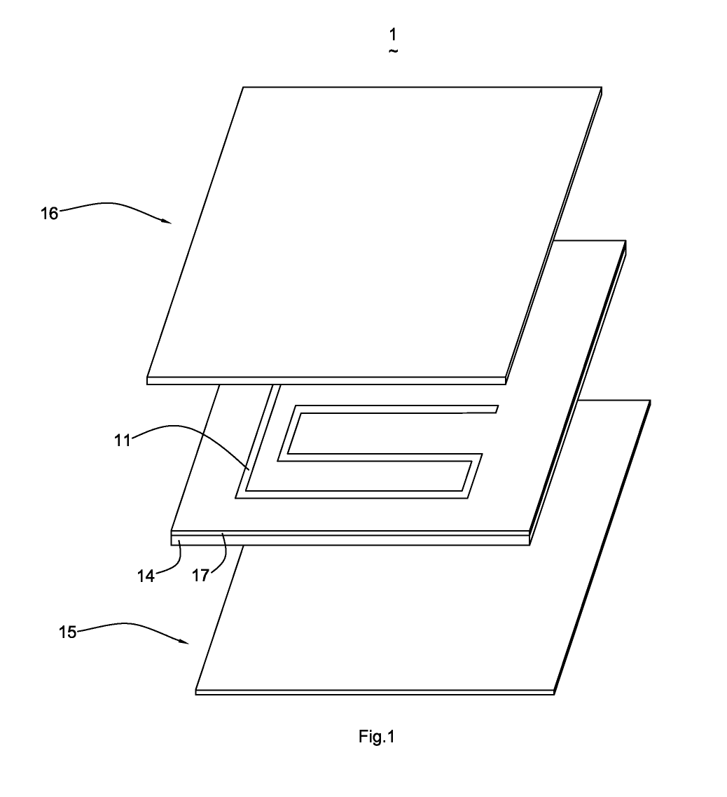

Referring to FIG. 1, an antenna 1 includes a ferrite plate 14, an adhesive layer 17 attached to a first face of the ferrite plate 14, an antenna pattern 11 disposed on the adhesive layer 17, a plastic film 15 attached to a second face of the ferrite plate 14 opposite to the first face, and a double-faced adhesive tape 16 attached to the antenna pattern 11 so that the antenna 1 is able to be pasted to a selected terminal.

The ferrite plate 14 is made from ferrite material. By virtue of its high resistivity and magnetic permeability, the ferrite plate 14 is able to lead the environmental magnetic field. The plastic film 15 is made from transparent polyester film.

A method for manufacturing the antenna 1 described above comprises the processes which are described below.

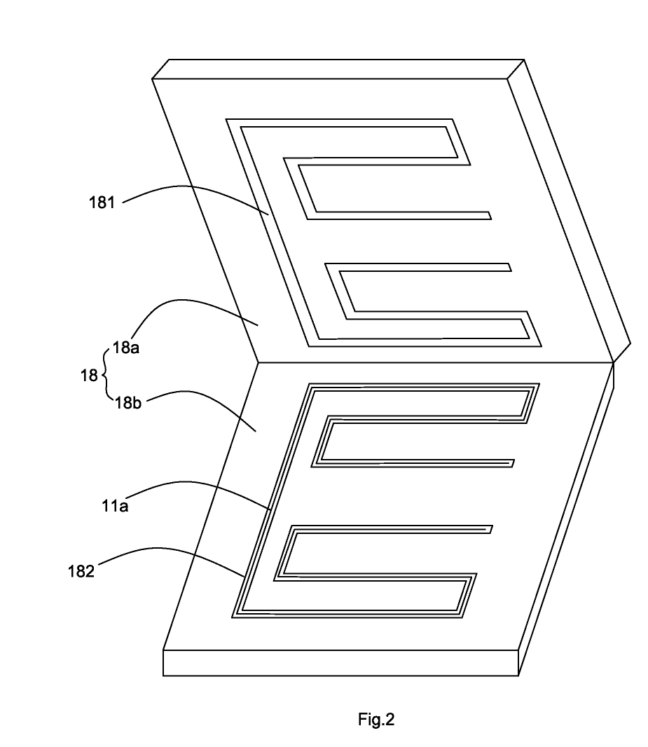

Firstly, referring to FIG. 2, provide a wire 11a and a stamping tool 18 including an upper portion 18a with a first pattern shaping region 181 and a lower portion 18b with a second pattern shaping region 182 matching with the first pattern shaping region 181, and put the wire 11a in the second pattern shaping region 182. The wire 11a is optionally made from copper;

Secondly, stamp the wire 11a to a flat antenna pattern 11 by engaging the upper portion 18a and the lower portion 18b of the stamping tool 18;

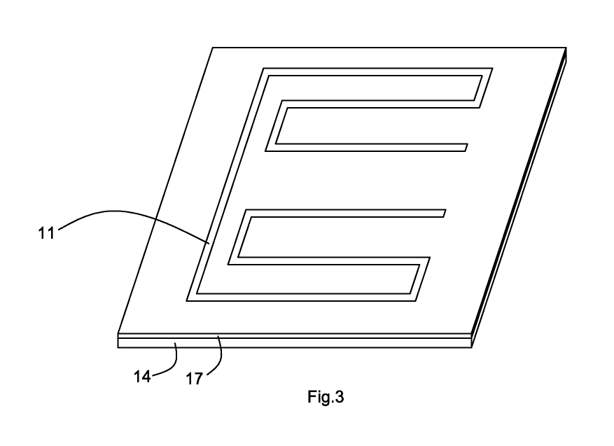

Thirdly, referring to FIG. 3, provide a ferrite plate 14 with an adhesive layer 17 disposed on a first face thereof and paste the antenna pattern 11 to the adhesive layer 17;

Fourthly, referring back to FIG. 1, provide a plastic film 15 attached to a second face of the ferrite plate 14, and provide a double-faced adhesive tape 16 attached to the antenna pattern 11.

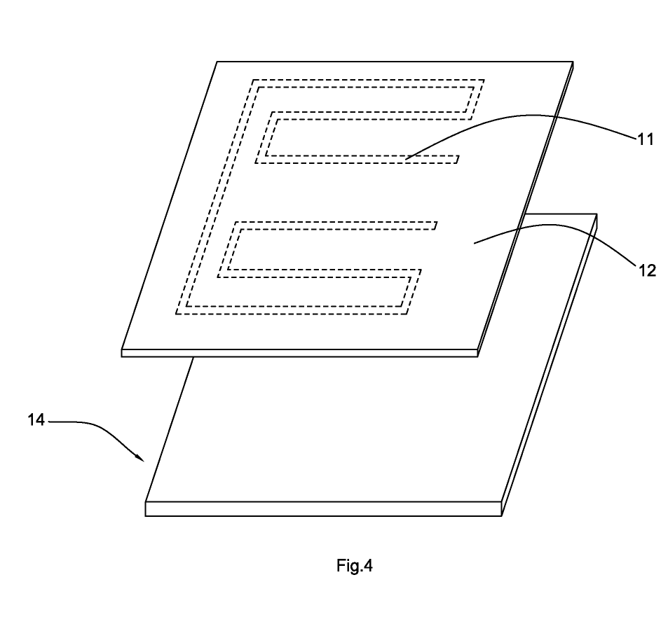

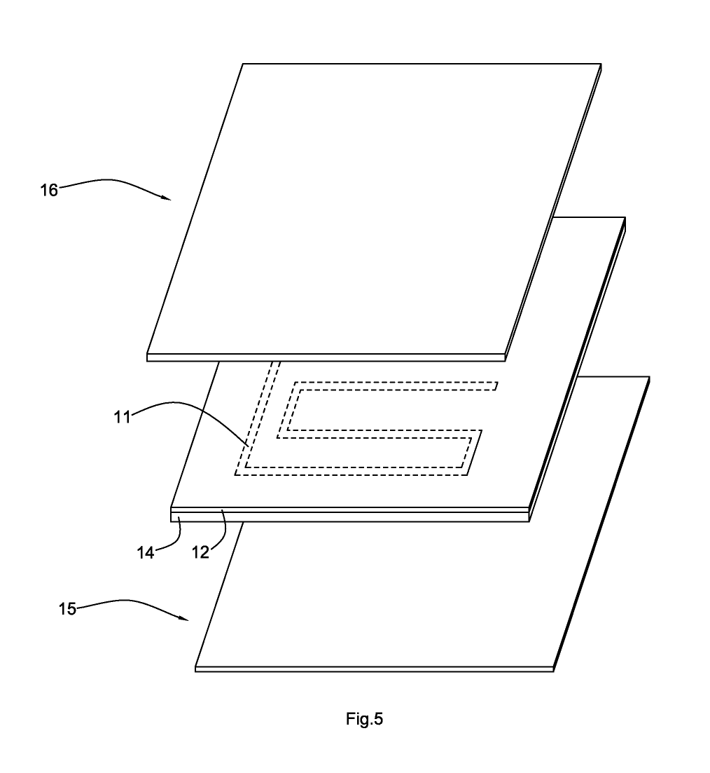

Referring to FIGS. 4 and 5, in another embodiment, an adhesive tape 12 is used to replace the adhesive layer described in the forth-mentioned embodiment. The antenna pattern 11 is pasted to the adhesive tape 12, then the adhesive tape 12 is pasted to the first face of the ferrite plate 14 with the antenna pattern 11 disposed between the adhesive tape 12 and the ferrite plate 14. A plastic film 15 is provided to be attached to the second face of the ferrite plate 14, and a double-faced adhesive tape 16 is attached to the antenna pattern 11.

The thickness of the wire 11a could be reduced by 50%-80% after being stamped by the stamping tool 18. Therefore, the thickness of the antenna pattern 11 is only 0.07 mm due to the wire 11a has a diameter of 0.3 mm

The antenna according to the present disclosure has an antenna pattern with a thickness of only 0.07 millimeters which is much smaller than the one made from FPCB. Otherwise, the method is easy for mass production and the cost thereof is accordingly cut down. In addition, the antenna made by the above-mentioned processes has a stable structure and good flexibility.

In another alternative embodiment, the wire 11a is made from silver or gold, and the antenna pattern is made by cutting a metallic plate.

It will be understood that the above-mentioned particular embodiments is shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A method for manufacturing an antenna, the method comprising the steps of:
providing a wire and a stamping tool;
stamping the wire into a flat antenna pattern by the stamping tool;
providing a ferrite plate with the antenna pattern attached to the ferrite plate.

2. The method for manufacturing an antenna as claimed in claim 1, wherein the ferrite plate includes an adhesive layer disposed on one face thereof, and the antenna pattern is attached to the adhesive layer.

3. The method for manufacturing an antenna as claimed in claim 2, wherein a plastic film is provided pasted to a second face of the ferrite plate opposite to the first face, and a double-faced adhesive tape is provided attached to the antenna pattern.

4. The method for manufacturing an antenna as claimed in claim 1, wherein an adhesive tape is provided to be pasted the antenna pattern after stamping the wire, and the adhesive tape is pasted to a first face of the ferrite plate.

5. The method for manufacturing an antenna as claimed in claim 4, wherein the antenna pattern is disposed between the adhesive tape and the ferrite plate.

6. The method for manufacturing an antenna as claimed in claim 5, wherein a plastic film is provided pasted to a second face of the ferrite plate opposite to the first face, and a double-faced adhesive tape is provided attached to the adhesive tape.

7. The method for manufacturing an antenna as claimed in claim 1, wherein the metallic material of the wire is selected from copper, sliver, gold.

8. The method for manufacturing an antenna as claimed in claim 1, wherein the stamping tool includes an upper portion with a first pattern shaping region and a lower portion with a second pattern shaping region matching with the first pattern shaping region.

9. The method for manufacturing an antenna as claimed in claim 8, wherein the wire is put in the second pattern shaping region, and the upper and lower portion are engaged together for stamping the wire.

10. An antenna, comprising:
a ferrite plate including a first face and a second face opposite to the first face;
an adhesive layer disposed on the first face of the ferrite plate;
an antenna pattern attached on the adhesive layer;
and a plastic film disposed on the second face of the ferrite plate.

11. The antenna as claimed in claim 10, wherein the antenna pattern is made by stamping a copper wire.

12. The antenna as claimed in claim 10 further comprising a double-faced adhesive tape disposed on the antenna pattern.

13. The antenna as claimed in claim 10, wherein the plastic film is made from transparent polyester film.

14. An antenna, comprising:
a ferrite plate including a first face and a second face opposite to the first face;
an adhesive tape disposed on the first face of the ferrite plate;
an antenna pattern disposed between the adhesive tape and ferrite plate.

15. The antenna as claimed in claim 14 further comprising a plastic film disposed on the second face of the ferrite plate.

16. The antenna as claimed in claim 14 further comprising a double-faced adhesive tape disposed on the antenna pattern.
